(19) United States
(12) Patent Application Publication
(10) Pub. No.: US 2026/0324554 A1
(43) Pub. Date: Oct. 22, 2026

(54) SPRING LOADED SPINDLE CLEANING ASSEMBLY FOR COTTON HARVESTING UNIT

(71) Applicant: Deere & Company, Moline, IL (US)

(72) Inventors: Adam R. Eaker, Ankeny, IA (US); Brandon C. Carlson, Ankeny, IA (US); Bing Hui Dong, Ankeny, IA (US); Madalyn G. Moline, Manson, IA (US)

(21) Appl. No.: 19/356,924

(22) Filed: Oct. 13, 2025

Related U.S. Application Data
(60) Provisional application No. 63/790,555, filed on Apr. 17, 2025.

(51) Int. Cl. A01D 46/14

(52) U.S. Cl. CPC A01D 46/14

(57) ABSTRACT

A spindling cleaning assembly for a harvesting unit of a cotton harvesting work vehicle is disclosed. The spindling cleaning assembly includes a housing panel configured to pivot relative to a housing of the harvesting unit about a pivot axis, a fluid assembly having distributor tubes carried by the housing panel, and a column of applicator pads carried by the housing panel and spaced apart along the pivot axis. The applicator pads receive fluid from the fluid assembly through the distributor tubes. The spindling cleaning assembly further includes a mounting assembly having a mounting bracket coupled to the housing of the harvesting unit and a spring configured to allow the housing panel to move along the pivot axis relative to the mounting bracket and housing of the harvesting unit.

### CROSS-REFERENCE TO RELATED APPLICATION(S)

This application claims the benefit of U.S. provisional application Ser. No. 63/790,555, filed April 17, 2025, which is incorporated herein in its entirety.

### STATEMENT OF FEDERALLY SPONSORED RESEARCH OR DEVELOPMENT

Not applicable.

### FIELD OF THE DISCLOSURE

This disclosure generally relates to a spindle cleaning assembly for lubricating and cleaning spindles in a cotton harvesting work vehicle.

### BACKGROUND OF THE DISCLOSURE

Cotton harvesting work vehicles include a cotton harvesting system and a moisture system. The cotton harvesting system includes spindles and doffers. The spindles rotate and separate the cotton from the plant, and the doffers strip the cotton off the spindles. Debris from the cotton plants (e.g., cotton, cotton sap, and/or other plant debris) may remain on the spindles after the doffer removes the cotton. As such, the cotton related debris may stick to the spindles and eventually build up on the spindles. To mitigate the build-up of debris, the spindles pass through a spindle cleaning assembly (e.g., a moisture column) of the moisture system to lubricate and clean the spindles to remove and help prevent the debris from sticking to the spindles.

### SUMMARY OF THE DISCLOSURE

In one implementation, a spindling cleaning assembly for a harvesting unit of a cotton harvesting work vehicle is disclosed. The spindling cleaning assembly may include a housing panel configured to pivot relative to a housing of the harvesting unit about a pivot axis, a fluid assembly having distributor tubes carried by the housing panel, and a column of applicator pads carried by the housing panel and spaced apart along the pivot axis. The applicator pads may receive fluid from the fluid assembly through the distributor tubes. The spindling cleaning assembly may further include a mounting assembly having a mounting bracket coupled to the housing of the harvesting unit and a spring configured to allow the housing panel to move along the pivot axis relative to the mounting bracket and housing of the harvesting unit.

In an example of the spindling cleaning assembly, the mounting assembly may further include an outer shaft surrounding the spring and an inner shaft assembly slidably coupled to the outer shaft. The outer shaft may be attached to the mounting bracket, and the spring may internally contact the outer shaft at a first end of the outer shaft. The inner shaft assembly may extend through the outer shaft and through the spring. The inner shaft assembly may contact the spring proximate a second end of the outer shaft opposite the first end. Compression of the spring may be configured to move the inner shaft assembly relative to the outer shaft.

In an example of the spindling cleaning assembly, the outer shaft may define a first cutout extending along the pivot axis and a second cutout extending along the pivot axis. An internal ledge may be formed between the first cutout and second cutout. The spring may be positioned within the first cutout. In a first position of the mounting bracket, the spring may produce a first spring force and the inner shaft assembly may contact the outer shaft outside of the outer shaft at the first end of the outer shaft. In a second position of the mounting bracket, the spring may produce a second spring force greater than the first spring force and the inner shaft assembly may rest against the internal ledge.

In an example of the spindling cleaning assembly, compressing the spring may move the mounting bracket from the first position to the second position, and a distance between the first position and the second position may define a maximum movement along the pivot axis between the spindling cleaning assembly and the housing of the harvesting unit. In an example of the spindling cleaning assembly, the outer shaft and mounting bracket form a single integral component.

In an example of the spindling cleaning assembly, during operation of the harvesting unit, a spindle holding bar of the harvesting unit may pass the spindling cleaning assembly and spindles of the spindle holding bar contact the column of applicator pads. The contact between the spindles and the column of applicator pads may generate a force causing the spring to compress moving the spindling cleaning assembly relative to the housing of the harvesting unit.

In an example of the spindling cleaning assembly, the mounting assembly may be positioned at a first end of the spindling cleaning assembly, and the spindling cleaning assembly may further include a mounting member positioned at a second end of the spindling cleaning assembly opposite the first end. The mounting member may be positioned along the pivot axis. In an example of the spindling cleaning assembly, the mounting member may include a rod attached to the housing panel, and the rod may extend away from the housing panel along the pivot axis.

In an example of the spindling cleaning assembly, the spindling cleaning assembly may further include a latching assembly configured to latch the housing panel against the housing of the harvesting unit. When the housing panel is in a closed position and the latch assembly is in a first position, the latch assembly may be configured to prevent rotation of the housing panel about the pivot axis. When the latch assembly is in a second position the latch assembly may be configured to allow the housing panel to rotate about the pivot axis. In an example of the spindling cleaning assembly, when the latching assembly is placed in the first position and the housing panel is the closed position, the latching assembly may engage a sleeve of the housing of the harvesting unit, and when the spring is compressed, the sleeve may be configured to move in a direction of the pivot axis.

In one implementation a harvesting unit of a cotton harvesting work vehicle is disclosed. The harvesting unit may include a housing, and a spindle drum mechanically coupled to the housing. The spindle drum may include an array of spindle holding bars configured to rotate about a rotation axis of the spindle drum. Each spindle holding bar may include a column of spindles. The harvesting unit may further include a spindle cleaning assembly for cleaning and lubricating each spindle of the column of spindles. During rotation of the spindle drum each spindle holding bar passes through the spindle cleaning assembly. The spindle cleaning assembly may include a housing panel configured to pivot relative to the housing about a pivot axis, a fluid assembly having distributor tubes carried by the housing panel, and a column of applicator pads carried by the housing panel and spaced apart along the pivot axis. The applicator pads may receive fluid from the fluid assembly through the distributor tubes. The spindle cleaning assembly may further include a mounting assembly having a mounting bracket coupled to the housing and a spring configured to allow the housing panel to move along the pivot axis relative to the mounting bracket and housing.

In an example of the harvesting unit, the mounting assembly may further include an outer shaft surrounding the spring and an inner shaft assembly slidably coupled to the outer shaft. The outer shaft may be attached to the mounting bracket, and the spring may internally contact the outer shaft at a first end of the outer shaft. The inner shaft assembly may extend through the outer shaft and through the spring. The inner shaft assembly may contact the spring proximate a second end of the outer shaft opposite the first end. Compression of the spring may be configured to move the inner shaft assembly relative to the outer shaft.

In an example of the harvesting unit, the outer shaft may define a first cutout extending along the pivot axis and a second cutout extending along the pivot axis. An internal ledge may be formed between the first cutout and second cutout. The spring may be positioned within the first cutout. In a first position of the mounting bracket, the spring may produce a first spring force and the inner shaft assembly may contact the outer shaft outside of the outer shaft at the first end of the outer shaft. In a second position of the mounting bracket, the spring may produce a second spring force greater than the first spring force and the inner shaft assembly may rest against the internal ledge.

In an example of the harvesting unit, compressing the spring may move the mounting bracket from the first position to the second position, and a distance between the first position and the second position may define a maximum movement along the pivot axis between the spindling cleaning assembly and the housing of the harvesting unit. In an example of the harvesting unit, the outer shaft and mounting bracket form a single integral component.

In an example of the harvesting unit, during operation of the harvesting unit, a spindle holding bar of the harvesting unit may pass the spindling cleaning assembly and spindles of the spindle holding bar contact the column of applicator pads. The contact between the spindles and the column of applicator pads may generate a force causing the spring to compress moving the spindling cleaning assembly relative to the housing of the harvesting unit.

In an example of the harvesting unit, the mounting assembly may be positioned at a first end of the spindling cleaning assembly, and the spindling cleaning assembly may further include a mounting member positioned at a second end of the spindling cleaning assembly opposite the first end. The mounting member may be positioned along the pivot axis. In an example of the harvesting unit, the mounting member may include a rod attached to the housing panel, and the rod may extend away from the housing panel along the pivot axis.

In an example of the harvesting unit, the spindling cleaning assembly may further include a latching assembly configured to latch the housing panel against the housing of the harvesting unit. When the housing panel is in a closed position and the latch assembly is in a first position, the latch assembly may be configured to prevent rotation of the housing panel about the pivot axis. When the latch assembly is in a second position the latch assembly may be configured to allow the housing panel to rotate about the pivot axis. In an example of the harvesting unit, when the latching assembly is placed in the first position and the housing panel is the closed position, the latching assembly may engage a sleeve of the housing of the harvesting unit, and when the spring is compressed, the sleeve may be configured to move in a direction of the pivot axis.

### BRIEF DESCRIPTION OF THE DRAWINGS

FIG. 1 is a perspective view of an example cotton harvesting work vehicle in which the present disclosure may be incorporated;

FIG. 2 is a schematic diagram a harvesting unit of a cotton harvesting work vehicle being used to harvest cotton;

FIG. 3 is a perspective view of a cotton harvesting unit of the cotton harvesting work vehicle of FIG. 1;

FIG. 4 is a perspective view of a spindle cleaning assembly for a cotton harvesting unit of FIG. 3;

FIG. 5 is an enlarged partial detailed cross-section view taken along cross-section line 5-5 of FIG. 4;

FIG. 6 is a partial perspective view of a spindle rod passing by the spindle cleaning assembly within the cotton harvesting unit of FIG. 3;

FIG. 7 is a side view of the spindle cleaning assembly of FIG. 4;

FIG. 8 is a cross-section view thereof taken along cross-section line 8-8 of FIG. 7;

FIG. 9 is an enlarged partial detailed view of the area 9 of FIG. 8; and

FIG. 10 is the enlarged partial detailed view of FIG. 9 with a spindle rod passing by the spindle cleaning assembly.

Throughout the drawings, identical reference numbers designate the same element. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Example embodiments of the present disclosure are shown in the accompanying figures of the drawings described briefly above. Various modifications to the example embodiments may be contemplated by one of skill in the art without departing from the scope of the present invention, as set forth in the appended claims.

### OVERVIEW

Cotton harvesting work vehicles include a cotton harvesting system and a moisture system. The cotton harvesting system includes spindles and doffers. The spindles rotate and separate the cotton from the plant and the doffers strip the cotton off the spindles. The cotton may then be guided to a suction duct to move the cotton to a storage basket on the cotton harvesting work vehicle. Debris from the cotton plants (e.g., cotton, cotton sap, and/or other plant debris) may remain on the spindles after the doffer removes the cotton. As such, the debris may stick to the spindles and eventually build up on the spindles. To reduce and/or prevent the build-up of debris, the spindles pass through a spindle cleaning assembly (e.g., a moisture column) to lubricate and clean the spindles to prevent the debris from sticking to the spindles.

In the operation of cotton harvesting units, the spindle cleaning assembly plays a crucial role by distributing a lubricating and cleaning solution to the cotton harvesting spindles. The cleaning and fluid application is essential for enhancing harvest efficiency and preventing the accumulation of cotton debris. The spindle cleaning assembly features an array of applicator pads aligned such that spindles pass by and contact an applicator pad to facilitate this process. For example, as each spindle passes by the spindle cleaning assembly and the applicator pads contact the spindles and dispense a fluid through apertures onto the spindles. This solution is essential for maintaining optimal spindle performance and preventing excessive cotton build-up. However, during operations, the system can experience blockages (unit plugs) or excessive cotton accumulation, which may lead to damage of the spindle cleaning assembly. Such damage hampers the spindle cleaning assembly’s ability to perform its intended functions, ultimately affecting the efficiency of the cotton harvesting process.

The present disclosure provides a spindle cleaning assembly with an improved mounting assembly. The mounting assembly incorporates a spring at a pivot point of the spindle cleaning assembly, enabling the spindle cleaning assembly to flex and adapt under varying operational conditions. During an instance of an applicator pad plug or excessive cotton build-up on a spindle, the spring allows the spindle cleaning assembly to automatically create clearance from the spindles to prevent damage and maintain functionality. After the obstruction is cleared or cotton accumulation is resolved, the spring facilitates the return of the spindle cleaning assembly to its original position. This process allows the spindle cleaning assembly to adapt dynamically to operational conditions.

The mounting assembly is configured to allow the spindle cleaning assembly to move along the pivot axis relative to the housing of the cotton harvesting unit. The mounting assembly may include an outer shaft, the spring, an inner shaft, and a mounting bracket extending from the outer shaft. The mounting bracket may be attached to the housing of the cotton harvesting unit. The outer shaft, spring, and inner shaft may be positioned concentrically along the pivot axis. The spring may be positioned within the outer shaft and around the inner shaft. The spring may compress by moving the outer shaft toward the inner shaft along the pivot axis. The biasing force generated by the spring may be configured to move the outer shaft away from the inner shaft along the pivot axis. The compression of the spring may cause the mounting bracket and outer shaft to move along the pivot axis relative to the rest of the spindle cleaning assembly.

The mounting assembly may be attached to a housing panel of the spindle cleaning assembly by a positioning bolt. The positioning bolt may extend through the mounting assembly along the pivot axis and attached to the housing panel. The mounting assembly may rotate about the positioning bolt, which allows the spindle cleaning assembly to rotate about the pivot axis relative to the housing of the cotton harvesting unit. The positioning bolt may be used to position the housing panel along the pivot axis relative to the housing of the cotton harvesting unit. As such, the positioning bolt may be used to set the desired position of the applicator pads for contact with the spindles during operation of the cotton harvesting unit. During compression of the spring, the mounting bracket may move along the pivot axis relative to the positioning bolt.

The spindle cleaning assembly may include a latch assembly. The latch assembly may be used to hold the spindle cleaning assembly in a closed position for operation of the cotton harvesting unit. The latch assembly may engage an attachment assembly on the cotton harvesting unit. The attachment assembly may include an outer sleeve that may move relative to an inner shaft. The inner shaft may be bolted to the housing of the cotton harvesting unit. The latch assembly may contact the outer sleeve to lock the spindle cleaning assembly in the closed position. When the spring is compressed, the outer sleeve and latch assembly may move in the direction of the pivot axis to allow the spindle cleaning assembly to move along the pivot axis relative to the housing of the cotton harvesting unit.

An example embodiment of a spindle cleaning assembly is provided according to the present disclosure. The following description should be understood as merely providing one or more non-limiting example context in which embodiments of the present disclosure may be better understood.

### EXAMPLE SPINDLE CLEANING ASSEMBLY

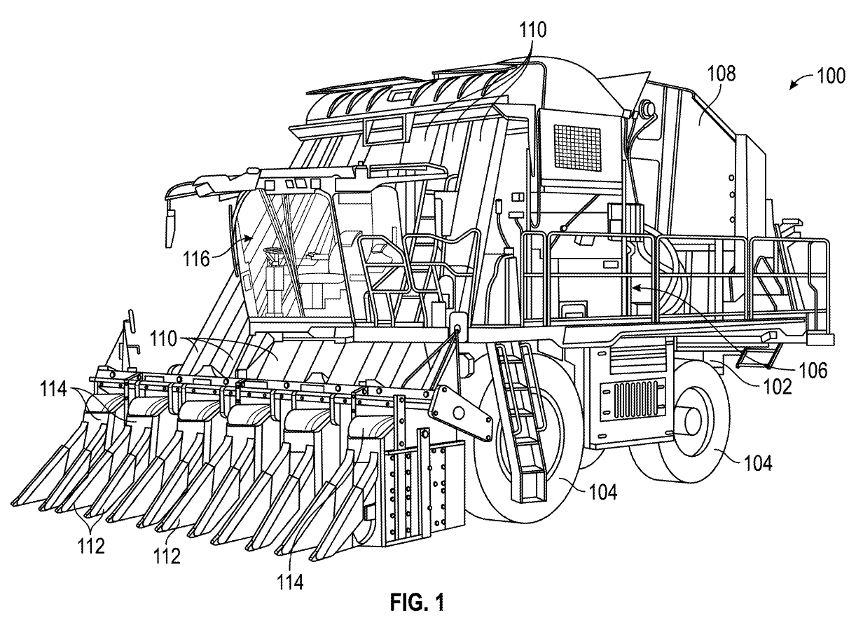

Referring to FIG. 1, a cotton harvesting work vehicle 100 is shown that can implement embodiments of the disclosure. In the illustrated example, the cotton harvesting work vehicle 100 is depicted as a cotton picker. The cotton harvesting work vehicle 100 includes a chassis 102 (i.e., frame) carried on front and rear wheels 104. Positioned in a middle region of the chassis 102 is an engine 106. The engine system provides power via an associated drivetrain to an output member (e.g., an output shaft, not shown) that, in turn, transmits power to axle(s) of the cotton harvesting work vehicle 100 to provide propulsion thereto and additionally powers the other implements of the cotton harvesting work vehicle 100.

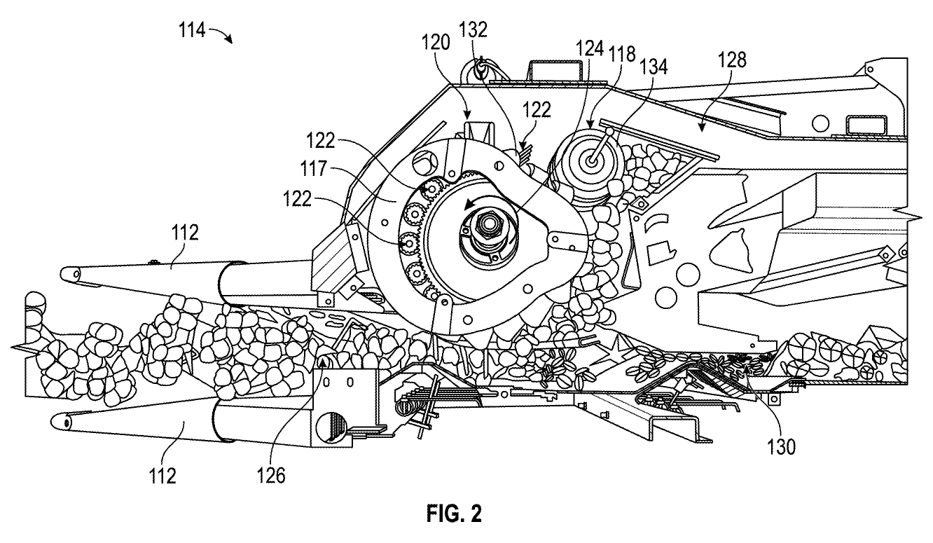

The cotton harvesting work vehicle 100 includes a basket 108, suction ducts 110, stalk lifters 112, and harvesting units 114. These implements may each be powered by the engine 106. Each harvesting unit 114 may have two stalk lifters 112 attached on an input 126 (FIG. 2) of the harvesting unit 114 and each harvesting unit 114 has a suction duct 110 connected to the output side of the harvesting unit 114. The suction ducts 110 extend from a harvesting unit 114 to the basket 108. As the cotton harvesting work vehicle 100 is operated, the stalk lifters 112 may lift and guide cotton stalks into the harvesting units 114. The harvesting units 114 strip the cotton off of the cotton stalks. The cotton stalks with the cotton removed travel through the cotton harvesting units 114 to be placed back on the ground. The harvested cotton may be suctioned through the suction ducts 110 and into the basket 108. The operator may operate the cotton harvesting work vehicle 100 to harvest cotton until the basket 108 full of cotton.

The cotton harvesting work vehicle 100 may include a controller to monitor parameters of the cotton harvesting work vehicle 100. For example, the cotton harvesting work vehicle 100 may include an operator cabin 116 including one or more display devices and any of various operator interfaces coupled to the controller. Apart from the display devices, the operator interface devices may include various video and audio devices for providing video and audio information, haptic devices that provide haptic feedback, levers, joysticks, steering wheels, pedals, buttons, and so on. Operator interface devices can also be a set of inputs displayed on the display devices, for example, links, icons, or other user actuatable mechanisms. Additionally, or alternatively, some portion of the operator interfaces may be integrated into the display devices, such that the operator interfaces may include physical inputs (e.g. buttons, switches, dials, etc.) on or near the display devices, a touchscreen module integrated into the display devices, or a cursor input device (e.g., a joystick, trackball, or mouse) for positioning a cursor utilized to interface with GUI elements generated on the display devices. The display devices can be any image-generating device configured for operation within the operator cabin, including one or more dedicated display consoles and various heads-up display projectors.

The display devices and operator interfaces are operatively coupled to the controller with various data connections between these components representative of wired and/or wireless data connections. The controller may have one or more controllers or other control architecture that can assume any form suitable for performing the functions described herein and is used in a non-limiting sense to generally refer to the processing architecture or system of the cotton harvesting work vehicle 100 or other computing device or group of devices. For example, the controller may encompass or may be corresponding to any practical number of processors, control computers, computer-readable memories, power supplies, storage devices, interface cards, and other standardized components, and may also include or cooperate with any number of firmware and software programs or computer-readable instructions designed to carry-out the various process tasks, calculations, and control/display functions described herein, all represented by a processor. Such computer-readable instructions may be stored within a non-volatile sector of a local onboard memory, which is accessible to the controller. While generically illustrated as a single block, the memory can encompass any number and type of storage media suitable for storing computer-readable code or instructions, as well as other data utilized to support the operation of the cotton harvesting work vehicle 100. The memory may be integrated into the controller architecture in various embodiments such as, for example, a system-in-package, a system-on-a-chip, or another type of microelectronic package or module.

The cotton harvesting work vehicle 100 may include a plurality of sensors coupled to the controller. The sensors may provide the controller with data regarding the different implements and/or engine of the cotton harvesting work vehicle 100. For example, the basket 108 may include a sensor to provide data indicative of the fullness the basket 108. Another example, is a sensor providing data indicative of how full a moisture tank is for the harvesting units 114. Another example, is a sensor providing data indicative of a jam occurring within a harvesting unit 114. There are various other sensors that may be on the cotton harvesting work vehicle 100. The controller monitors the signals or data received from the sensors and adjusts operation of the cotton harvesting work vehicle 100 based on the data. The controller may also provide the operator with information regarding the data. For example, providing the operator with information regarding how full the basket 108 is currently as well as other parameters of the cotton harvesting work vehicle 100.

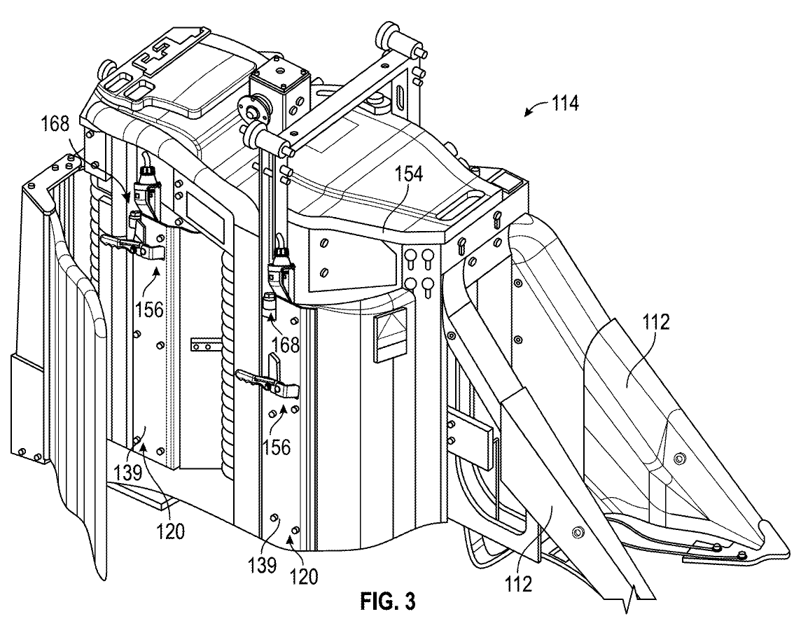

Referring to FIG. 2, each harvesting unit 114 may include a spindle drum 117, a doffer assembly 118, and a spindle cleaning assembly 120. The spindle drum 117 may include a plurality of spindle holding bars 132 and spindles 122 (FIG. 3) that rotate around the rotation axis 124. Each spindle holding bar 132 includes a plurality of spindles 122 attached along the spindle holding bar 132. Each spindle 122 attaches to the spindle holding bar 132 proximate a base of the spindle and extends to a distal end of the spindle 122. The spindle holding bar 132 may function as a spindle holding bar. Each harvesting unit 114 has an input 126, a cotton output 128, and a stalk output 130. The stalk lifters 112 may lift and guide cotton stalks into the input 126 of the harvesting unit 114. The cotton stalks may be guided to the spindle drum 117. The spindle holding bars 132 rotate around the rotation axis to move the spindles 122 into contact with the cotton stalks. Each spindle 122 rotates about itself to remove the cotton from the cotton stalk by twisting the cotton onto the spindle. Once the cotton is removed from the cotton stalk, the empty stalks are guided out the stalk output 130 and the stalks fall to or remain in the ground. The rotation of the spindle holding bar 132 moves the spindles 122 with cotton toward the doffer assembly 118. The doffer assembly 118 includes a plurality of doffers. In at least one aspect, each doffer may be a rubber disk. As the spindle holding bar 132 rotates past the doffer assembly 118, each spindle 122 may contact a doffer 134 and the doffer 134 may remove the harvested cotton from the spindle 122. For example, the doffers 134 may rotate faster than the spindle 122 and in an opposing direction to “unwind” the cotton from the spindle 122. The harvested cotton may then be guided out the cotton output 128 and into a suction duct 110 to be suctioned into the basket 108.

The spindle holding bar 132 and spindles 122 are then rotated around the rotation axis 124 toward the spindle cleaning assembly 120. The spindles 122 pass by and contact the spindle cleaning assembly 120, where the spindle cleaning assembly 120 cleans and lubricates each spindle 122 on the spindle holding bar 132. The cleaning and lubricating of the spindles 122 help to remove cotton debris and prevent buildup of cotton debris. After the spindle holding bar 132 and spindles 122 pass by the spindle cleaning assembly 120, the spindle holding bar 132 and spindles 122 continue to rotate around the rotation axis 124 on the spindle drum 117 to reach new cotton stalks that entered through the input 126. The spindles 122 harvest the cotton from these new stalks and the cycle of harvesting cotton and passing through the spindle cleaning assembly 120 continues as the spindle drum 117 rotates.

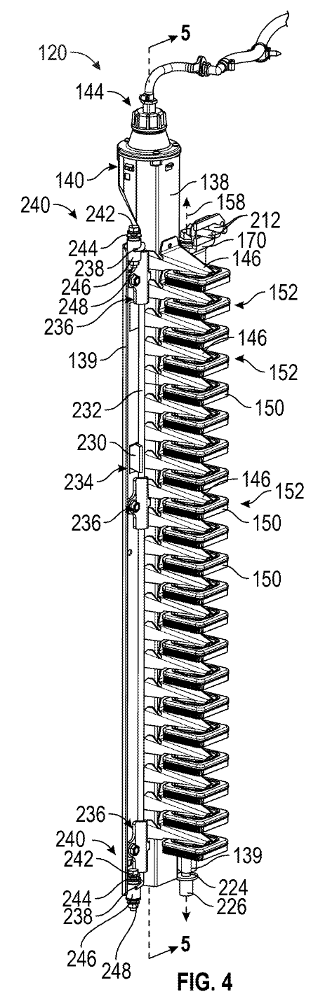

Referring to FIGS. 3 and 4, each harvesting unit 114 may have one or more spindle cleaning assemblies 120. The spindle cleaning assemblies 120 may include a housing 138, a fluid distributor 140, distributor tubes 142, a fluid inlet 144, and a column of applicator pad assemblies 136. The fluid distributor 140, distributor tubes 142, and fluid inlet 144 may be part of a fluid assembly of the spindle cleaning assembly 120. In at least one aspect, the spindle cleaning assembly 120 may be considered a moistener column. The column of applicator pad assemblies 136 may be attached and distributed along the housing 138. The distribution of the applicator pad assemblies 136 matches the distribution of spindles 122 along the spindle holding bar 132. This distribution allows the spindle holding bars 132 to rotate past the spindle cleaning assembly 120 and have applicator pads 150 of the applicator pad assemblies 136 contact the spindles 122 on the spindle holding bars 132.

Each applicator pad assembly 136 may include an applicator pad holder 146 and an applicator pad 150. Each applicator pad holder 146 attaches to the housing 138 and extends away from the housing 138 to a distal end 152 of the applicator pad holder 146. The applicator pad 150 is attached to the distal end 152. An applicator pad coupler may couple the applicator pad 150 to the distal end 152. For example, an applicator pad coupler may attach to both the distal end 152 and the applicator pad 150 to position the applicator pad 150 proximate the distal end 152.

The fluid for each spindle cleaning assembly 120 positioned within the harvesting units 114 may come from a fluid tank (not shown). The fluid inlet 144 may be coupled to the fluid tank by a tube 145. A pump (not shown) may pump fluid from the fluid tank down the tube 145 to reach each spindle cleaning assembly 120. The fluid may be pumped down the tube 145 at a pressure above a pressure threshold value. The pressure threshold value may be determined based on the number of spindle cleaning assembly 120 being supplied fluid by the pump. A controller of the cotton harvesting work vehicle 100 may control the pump to send liquid down the tube 145 to each spindle cleaning assembly 120 when the harvesting units 114 are operating. The control may then turn off the pump when the harvesting units 114 are not operating. This allows the fluid to only be sent to the applicator pads 150 of each spindle cleaning assembly 120 when the spindles 122 may be rotating around the rotation axis 124 and as such passing by the applicator pads 150.

The housing 138 may include a housing panel 139. The housing panel 139 may be attached to the housing 154 of the cotton harvesting unit 114 to position the spindle cleaning assembly 120 relative to the cotton harvesting unit 114. The spindle cleaning assembly 120 may be pivotable about a pivot axis relative to the housing 154. The housing panel 139 may function as a door protecting the spindle cleaning assembly 120 and preventing debris from entering the cotton harvesting unit 114. The housing panel 139 may be pivotable from a closed position to an open position. An operator may move the housing panel 139 to the open position to access the applicator pads 150 of the spindle cleaning assembly 120. For example, the operator may need to clean, inspect, or replace the applicator pads 150 due to damage and/or buildup of cotton debris. As such, the operator may move the housing panel 139 from the closed position to the open position to access the applicator pads 150.

Each spindle cleaning assembly 120 may include a latch assembly 156 configured to hold the housing panel 139 in the closed position. The latch assembly 156 may be configured to latch the housing panel 139 against the housing 154 of the cotton harvesting unit 114. When the housing panel 139 is in a closed position and the latch assembly 156 is in a first position, the latch assembly is configured to prevent rotation of the housing panel 139 about the pivot axis 158. For example, when the latching assembly 156 is placed in the first position and the housing panel 139 is in the closed position, the latching assembly 156 engages with the housing 154 or a component of the housing 154 to prevent rotation of the housing panel 139 about the pivot axis 158. When the latch assembly 156 is in a second position the latch assembly 156 is configured to allow the housing panel 139 to rotate about the pivot axis 158. For example, when the latching assembly 156 is placed in the second position the latching assembly 156 may disengage with the housing 154 or a component of the housing 154 to allow rotation of the housing panel 139 about the pivot axis 158.

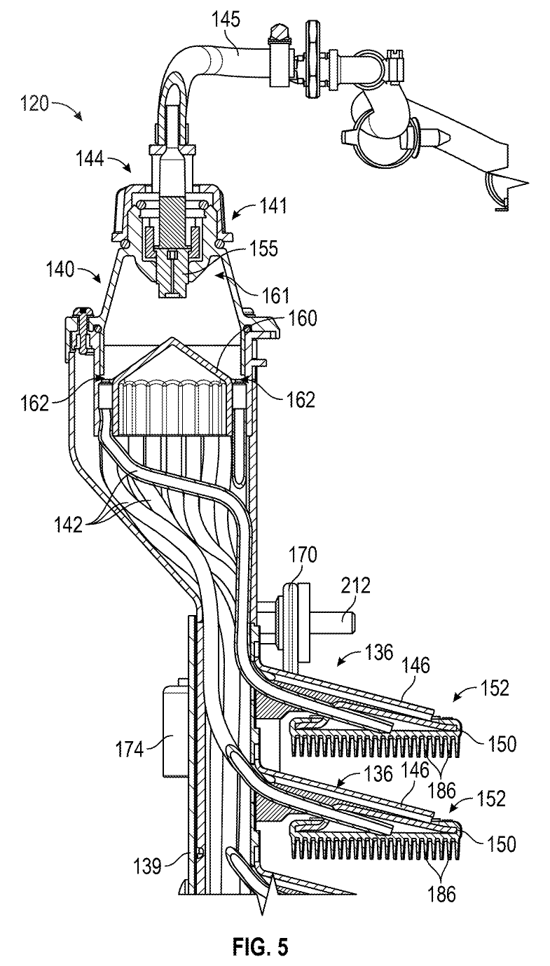

Referring to FIG. 5, pressurized fluid enters the fluid inlet 144 at the top of the fluid inlet 144. The fluid inlet 144 may be received within the fluid distributor 140. For example, the fluid inlet 144 may insert into the fluid distributor 140 and a part of the fluid inlet 144 may attach to the fluid distributor 140 at a receiving end 141. The fluid distributor 140 defining an interior distribution chamber 161 of the fluid distributor 140. The fluid inlet 144 may include a nozzle 155 extending away from the fluid inlet 144. The fluid inlet 144 may be received by the fluid distributor such that the nozzle 155 sprays fluid into the interior distribution chamber 161. In at least one aspect, the nozzle 155 may spray a hollow cone of fluid. In at least one aspect, the fluid that passes through the nozzle 155 is no longer under pressure after passing through the nozzle 155.

The nozzle 155 may spray the fluid onto an impingement plate 160 within the fluid distributor 140. The fluid may flow down the impingement plate 160 to reach one of an array of fluid outputs 162 of the fluid distributor 140, where each output is connected to a distributor tube 142. The distributor tubes 142 may extend from the fluid distributor 140 to an applicator pad assembly 136 to fluidically couple the fluid distributor 140 to an applicator pad 150. The distributor tubes 142 are housed within the housing 138 and exit the housing 138 to inside of an applicator pad holder 146. The distributor tube 142 extends down the applicator pad holder 146 to reach the applicator pad 150. The fluid exiting the fluid distributor 140 may travel through the distributor tubes 142 to reach an applicator pad 150. In at least one aspect, the fluid is gravity fed through the distributor tubes 142.

Each applicator pad 150 includes one or more contact features 186 projecting away from the applicator pad 150. The one or more contact features 186 may contact a spindle 122 as a spindle 122 moves past the applicator pad 150. The contact features 186 may be flexible and would not break due to contact with the spindle 122. The contact between the applicator pad 150 and the one or more contact features 186 may help to remove any buildup of debris from the cotton plants. The one or more contact features 186 may also help spread the fluid sprayed through the through holes in the applicator pad 150 onto the spindle 122 surface. Each of the one or more contact features 186 may be tapered. In at least one aspect, the one or more contact features 186 may be fins positioned across the applicator pad 150. The one or more contact features 186 may be spaced and positioned along the entire applicator pad 150.

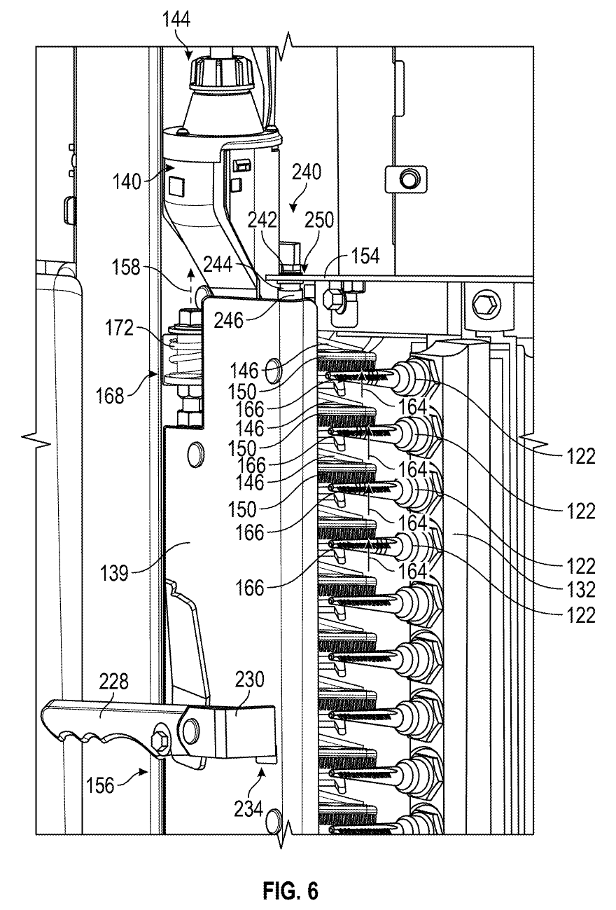

Referring to FIG. 6, during operation of the cotton harvesting work vehicle, the cotton harvesting units 114 may be engaged. Cotton is harvested during the operation of the cotton harvesting units 114 as described regarding FIG. 2. During the operation of the cotton harvesting units 114, the spindle holding bars 132 rotate about the spindle drum 117 and the spindles 122 contact the applicator pads 150 of the spindle cleaning assembly 120. If there is cotton debris buildup 166 on the spindle 122, then the spindle 122 may apply a damaging amount of force 164 on the applicator pad 150 that spindle 122 is contacting. Not every spindle 122 may have debris buildup 166. FIG. 6 shows 4 spindles having cotton debris buildup 166 and applying a force 164 against the spindle cleaning assembly 120, while the remaining spindles 122 on the spindle holding bar 132 do not have a build of debris.

The force 164 may cause damage to the applicator pad 150 contacting the spindle 122 with debris buildup 166 and/or damage to the applicator pad holder 146 positioning the applicator pad 150 contacting the spindle 122 with debris buildup 166. For example, the contacting features 186 may bend or break and/or the applicator pad holder 146 may bend or break. If this occurs, then the debris buildup issue may be exacerbated. The force 164 may be caused by debris buildup 166 being wrapped around a spindle 122. The cotton debris buildup 166 may increase the diameter of the spindle 122 causing the spindle 122 to apply a force 164 to the applicator pad 150 as the spindle 122 contacts the applicator pad 150 to be cleaned and lubricated. The increased diameter from the debris buildup 166 may cause the force 164 to be great and damaging. To mitigate the damage or have no damage occur, the spindle cleaning assembly 120 may have a mounting assembly 168 between the housing panel 139 and the housing 154 that allows the spindle cleaning assembly 120 to move along the pivot axis 158 relative to the housing 154. The mounting assembly 168 may allow the force 164 to cause the housing panel 139 to move along the pivot axis 158 instead of causing damage to the applicator pad 150 and/or applicator pad holder 146. This movement allows the spindle cleaning assembly 120 to account for an increase in diameter of a spindle 122 due to any debris buildup 166.

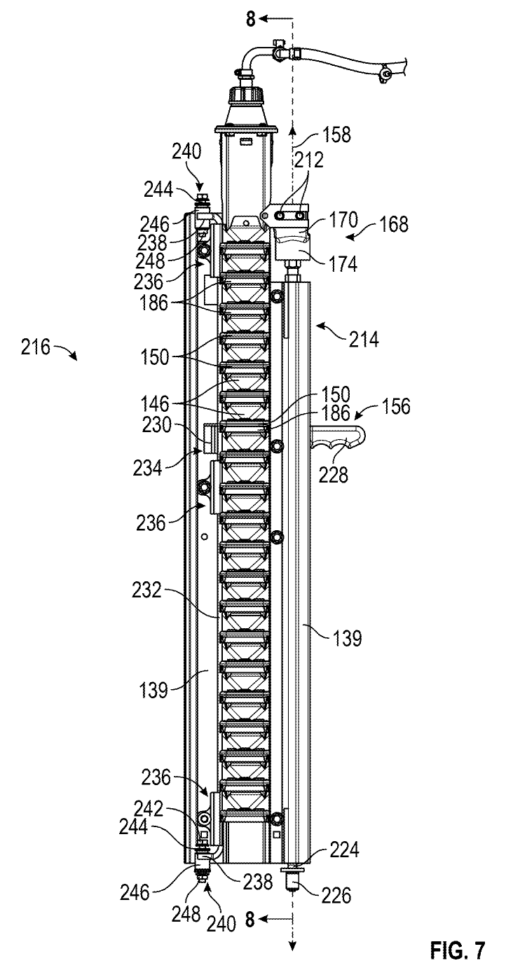

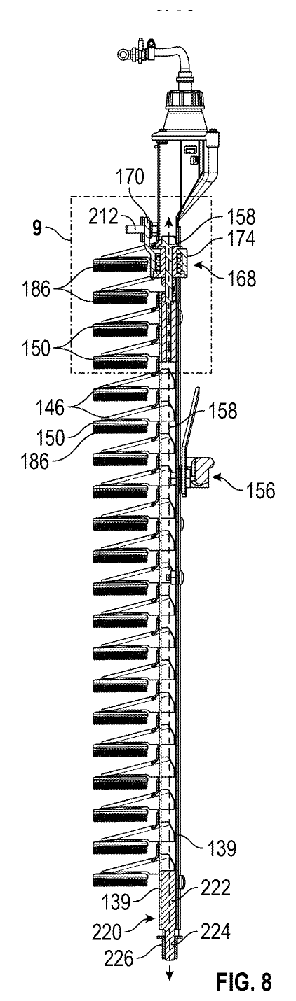

Referring to FIGS. 7-10, the mounting assembly 168 may include a mounting bracket 170, a spring 172, an outer shaft 174, an inner shaft assembly 176, a positioning bolt 178, a first locking nut 180, a second locking nut 182 and attachment member 184. The mounting bracket 170 may extend away from the outer shaft 174. In at least one aspect, the outer shaft 174 and mounting bracket 170 may form a single integral component. In an alternative aspect, the outer shaft 174 and mounting bracket 170 may be mechanically coupled together. The mounting bracket 170 may define mounting holes through which mounting bolts 212 may bolt the mounting bracket 170 to the housing 154 of a cotton harvesting unit 114. As such, the mounting bracket 170 and outer shaft 174 may be fixed relative to the housing 154 of a cotton harvesting unit 114.

The outer shaft 174 may have a top end 188 and a bottom end 190 opposite the top end 188. The top end 188 may define a through-hole 192. A first cutout 194 may extend from the bottom end 190 of the outer shaft 174 toward the top end 188. The first cutout 194 may not extend through the entire outer shaft 174. The first cutout 194 may be aligned with the through-hole 192. A second cutout 196 may extend from the bottom end 190 of the outer shaft 174 toward the top end 188. The second cutout 196 may have a diameter larger than a diameter of the first cutout 194 forming a ledge 198. The second cutout 196 may not extend as far as the first cutout 194. The second cutout 196 may be aligned with the through-hole 192 and the first cutout 194. The through-hole 192, first cutout 194, and second cutout 196 may be positioned along the pivot axis 158.

The inner shaft assembly 176 may have a top end 200 and a bottom end 202 opposite the top end 200. The inner shaft assembly 176 may extend through the outer shaft 174. For example, the inner shaft assembly 176 may extend through the through-hole 192. The top end 200 of the inner shaft assembly 176 may be positioned outside of the top end 188 of the outer shaft 174. The bottom end 202 may be positioned within the second cutout 196 of the outer shaft 174.

The inner shaft assembly 176 may include a shaft 204 and a washer 206. The shaft 204 may include a base portion 208 and a body portion 210. The base portion 208 may have a diameter greater than a diameter of the body portion 210. The shaft 204 may define a through-hole extending through the shaft 204. The base portion 208 may be positioned within the second cutout 196 of the outer shaft 174. The body portion 210 may extend through the second cutout 196, the first cutout 194, and through the through-hole 192 of the outer shaft 174. The washer 206 may be positioned against the body portion 210 outside the outer shaft 174 at the top end 188. The positioning bolt 178 may extend through the washer 206 and through the through-hole in the shaft 204. The first locking nut 180 may be threaded onto the positioning bolt 178 to tighten the shaft 204 against the washer 206. In an alternative aspect, the shaft 204 may be two components where the base portion 208 may be a washer and the body portion 210 may be a shaft or sleeve.

The spring 172 may be positioned between the inner shaft assembly 176 and the outer shaft 174. For example, the spring 172 may be positioned around the inner shaft assembly 176 and be surrounded by the outer shaft 174. The spring 172, inner shaft assembly 176, and outer shaft 174 may be concentrically positioned along the pivot axis 158. The spring 172 may contact the bottom of the first cutout 194 at the top end 188 of the outer shaft 174 and the base portion 208 at the bottom end 190 of the inner shaft assembly 176. The inner shaft assembly 176 may move/slide toward the outer shaft 174 along the pivot axis 158 to compress the spring 172. The spring 172 may apply a biasing force to move the inner shaft assembly 176 away from the outer shaft 174 along the pivot axis 158. In at least one aspect, the spring 172 is a compression spring.

The positioning bolt 178 extends through the outer shaft 174, the inner shaft assembly 176, and the spring 172. The first locking nut 180 may thread onto the mounting bolt to tighten the inner shaft assembly 176 together. The first locking nut 180 also maintains the inner shaft assembly 176, spring 172, and outer shaft 174 together. For example, the washer 206 prevents the inner shaft assembly 176 from sliding completely through the through-hole 192 in a first direction, and the base portion 208 would contact the ledge 198 to prevent the inner shaft assembly 176 from sliding completely through the through-hole 192 in the opposite direction.

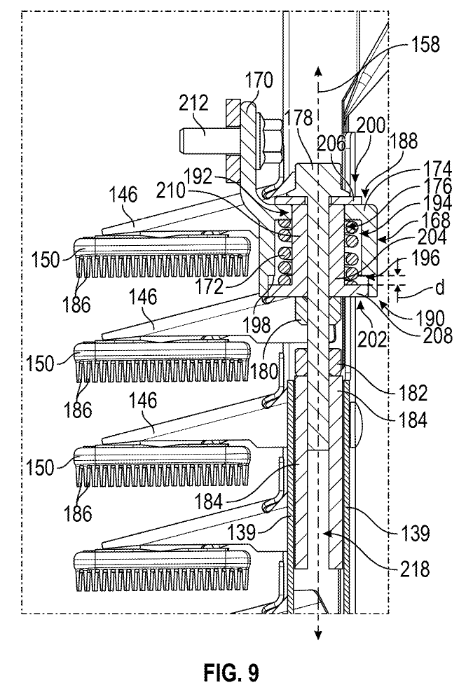

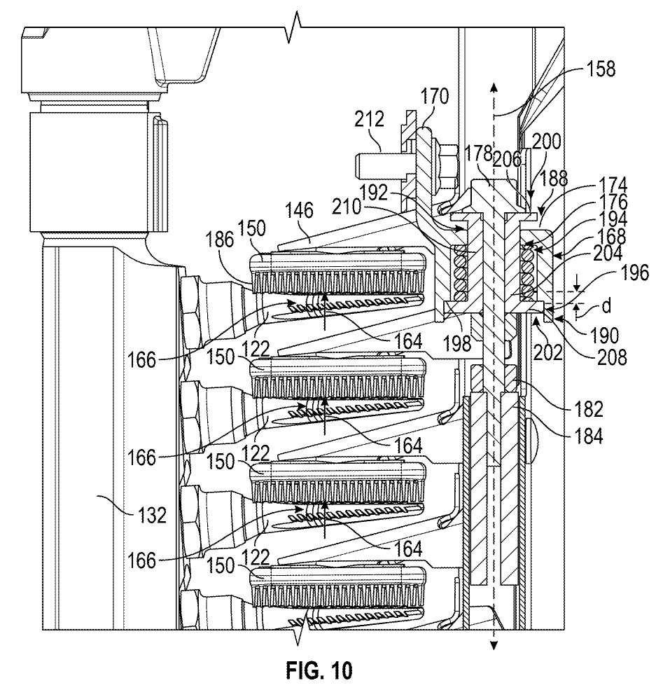

Referring to FIG. 9, once the first locking nut 180 is tightened, the distance “d” is the maximum travel between the inner shaft assembly 176 and the outer shaft 174. As such, this distance “d” is the maximum compression of the spring 172. For example, as shown in FIG. 10, the base portion 208 rests against the ledge 198 after the distance “d” is traveled. In at least one aspect, the distance “d” may be between 2 to 10 mm. In an alternative aspect, the distance “d” may be 3.5 mm. In at least one aspect, when the spring is compressed, the spring 172 may produce a biasing force of between 50 lbf to 500 lbf. Referring to FIG. 9, the spring 172 is in a first position. In the first position, the spring 172 may be compressed from tightening the first locking nut 180. As such, the spring 172 may be producing a first biasing force against the inner shaft assembly 176 and the outer shaft 174. In the first position, the washer 206 is in contact with the top end of the outer shaft 174. Referring to FIG. 10, the spring 172 is in a second position after being compressed the distance d. In the second position, the spring 172 produces a second biasing force against the inner shaft assembly 176 and the outer shaft 174, where the second biasing force is greater than the first biasing force. The compression of the spring 172 moves the mounting bracket 170 and outer shaft 174 relative to the inner shaft assembly 176. As shown in FIG. 10, the base portion 208 is resting against the ledge 198 in the second position.

Referring to FIGS. 7-10, the attachment member 184 may be a shaft attached to the housing panel 139 at a top end of a pivot side 214 of the housing panel 139. For example, the attachment member 184 may be welded to the housing panel 139. The housing panel 139 may be shaped to wrap around the attachment member 184 on the pivot side 214. The housing panel 139 wrapping around the attachment member 184 may help strengthen the attachment. The attachment member 184 have a threaded through-hole 218 extending through the attachment member 184. The positioning bolt 178 extends and threads into the attachment member 184. In at least one aspect, the attachment member 184 may act as a long nut.

The positioning bolt 178 may thread into the attachment member 184 to set the initial distance between the passing spindles 122 and applicator pads 150. For example, when the mounting bracket 170 is attached to the housing 154 of the cotton harvesting unit 114, threading the positioning bolt 178 into the attachment member 184 moves the housing panel 139 and the entire spindle cleaning assembly 120 along the pivot axis 158 relative to the housing 154. As such, the positioning bolt 178 may be threaded into the attachment member 184 to set the distance and/or amount of contact desired between the applicator pads 150 and the spindles 122 that move past the applicator pads 150 during operation. Once the desired distance is set, the second locking nut 182 may be tightened against the attachment member 184 to lock the positioning bolt 178 in position relative to the attachment member 184.

The mounting assembly 168 mechanically couples the housing panel 139 to the housing 154 of the cotton harvesting unit 114 at the top end of the pivot side 214. The mounting assembly 168 may rotate relative to the positioning bolt 178 to allow the housing panel 139 to pivot about the pivot axis 158. Stated another way, the mounting bracket 170 and outer shaft 174 may be allowed to rotate relative to the positioning bolt 178 which extends along the pivot axis 158. This rotation about the pivot axis 158 allows the housing panel 139 to rotate about the pivot axis 158 relative to the housing 154.

The housing panel 139 is also mechanically coupled to the housing 154 at the bottom end of the pivot side 214 opposite the top end. A mounting member 220 may be attached at the bottom end of the pivot side 214. The mounting member 220 may have a base shaft portion 222 and an extending shaft portion 224. The base shaft portion 222 may be welded to the housing panel 139 with the extending shaft portion 224 extending away from the housing panel 139 along the pivot axis 158. The housing panel 139 may be shaped to wrap around the base shaft portion 222 on the pivot side 214. The housing panel 139 wrapping around the base shaft portion 222 may help strengthen the attachment. The extending shaft portion 224 may be a rod extending away from the housing panel 139 along the pivot axis 158. A bushing 226 may be inserted into a hole in the housing 154 of the cotton harvesting unit 114. The extending shaft portion 224 may insert into the bushing 226. The extending shaft portion 224 may rotate about the pivot axis 158 within the bushing 226 and move along the pivot axis 158 within the bushing 226.

The housing panel 139 and spindle cleaning assembly 120 may pivot about the pivot axis 158 to move between the open and closed positions. The closed position being shown in FIGS. 3 and 6. The housing panel 139 may pivot about the pivot axis 158 due to the extending shaft portion 224 being rotatable within the bushing 226 and the mounting assembly 168 being rotatable about the positioning bolt 178. If the spring 172 is compressed, the housing panel 139 may move along the pivot axis 158 relative to the housing 154. The compression of the spring 172 may move the positioning bolt 178 relative to the mounting bracket 170 and outer shaft 174. Additionally, the compression of the spring 172 may have the extending shaft portion 224 move along the pivot axis 158 within the bushing 226. The spring 172 may be compressed in the open or closed positions. During operation of the cotton harvesting unit 114, the housing panel 139 would be in the closed position.

Referring to FIGS. 4, 6 and 7, the latch assembly 156 may be used to latch the housing panel 139 in the closed position. The latch assembly 156 may include a handle 228, an extension arm 230, and a latch bar 232. The handle 228 may be attached to the extension arm 230. The handle 228 being attached to the housing panel 139 on the opposite side from the applicator pads 150. The extension arm 230 may extend from the handle 228 and pass through an opening 234 in the housing panel 139. The extension arm 230 may attach to the latch bar 232 after passing through the opening 234.

The latch bar 232 may extend along the housing panel 139 with the extension arm 230 attaching in a middle portion of the latch bar 232. The latch bar 232 may extend through mounting brackets 236 that attach the latch bar 232 to the housing panel 139 and allow the latch bar 232 to rotate. The latch bar 232 is positioned on the latch side 216 of the housing panel 139. The latch bar 232 may extend to the top end and bottom end of the latch side 216. At both ends, the latch bar 232 may end in hooks 238.

The handle 228 and extension arm 230 may move together towards or away from the opening 234 to rotate the latch bar 232. When the housing panel 139 is in the closed position, the handle 228 and extension arm 230 may be moved from a first position to a second position to cause latch bar 232 to rotate and the hooks 238 to engage with attachment assemblies 240 of the housing 154 of the cotton harvesting unit 114. This engagement with the hooks 238 may latch the housing panel 139 in the closed position.

The attachment assembly 240 may include a bolt 242, an inner shaft 244, an outer sleeve 246, and a nut 248. The bolt 242 may be inserted through a hole 250 (FIG. 6) in the housing 154. The inner shaft 244 may be positioned on the bolt 242 with the outer sleeve 246 position around the inner shaft 244 and configured to slide relative to the inner shaft 244. A nut 248 may tighten the inner shaft 244 and bolt 242 against the housing 154. The nut 248 may keep the outer sleeve 246 from sliding off of the inner shaft 244. The attachment assembly 240 may be attached to the housing 154 at the location of the top end and bottom end of the latch side 216 of the housing panel 139, when the housing panel 139 is in the closed position. With the housing panel 139 in the closed position, the handle 228 and extension arm 230 may move together from the first position to the second position to cause the latch bar 232 to rotate causing the hooks 238 to rotate around and hook with the outer sleeve 246. When the latch bar 232 is engaged with the outer sleeve 246 and the spring 172 is compressed, the outer sleeve 246 may move along the inner shaft 244 in the direction of the pivot axis 158 to allow the housing panel 139 to move along the pivot axis 158 relative to the housing 154.

Referring to FIGS. 9 and 10, the mounting assembly 168 is configured to allow the housing panel 139 as well as the rest of the spindle cleaning assembly 120 to move along the pivot axis 158 relative to the mounting bracket 170 and housing 154 of the cotton harvesting unit 114. FIG. 9 shows the housing panel 139 and spring 172 in a first position. The distance d is the maximum movement along the pivot axis 158 between the housing panel 139 and the housing 154 of the cotton harvesting unit 114. FIG. 10 shows the housing panel 139 and spring 172 in a second position after the spring has been compressed the distance d.

Referring to FIG. 10, as discussed previously, during operation of the cotton harvesting unit 114, a spindle holding bar 132 of the cotton harvesting unit 114 passes the spindling cleaning assembly 120. The spindles 122 of the spindle holding bar 132 contact the column of applicator pads 150 to lubricate and clean the spindles 122. The spindles 122 may have debris buildup 166 over time even with them being lubricated and cleaned. When the spindles with debris buildup 166 contact the applicator pads 150 a force 164 may be generated. The force 164 may overcome the spring biasing force and cause the spring 172 to compress from the first position (FIG. 9) toward or to the second position (FIG. 10). The second position being the maximum distance the spindle cleaning assembly 120 may move along the pivot axis 158 relative to the housing 154.

The compression of the spring 172 may allow the spindle cleaning assembly 120 and applicator pads 150 to move along the pivot axis 158 relative to the housing 154 and spindles 122. This movement may prevent damage to the spindle cleaning assembly 120 from the force generated by the contact with the spindles 122 having debris buildup 166. The movement also allows the spindles 122 with debris buildup 166 to still be in contact with the applicator pads 150 and the applicator pads 150 may begin to remove the debris buildup 166. Then once the spindles 122 with debris buildup 166 rotate past the applicator pads 150, the spring 172 will expand and move from the second position back to the first position and be ready to receive another spindle holding bar 132. In this way, the spindle cleaning assembly 120 may prevent damages due to debris buildup 166 and be prepared to clean spindles 122 with or without debris buildup.

Although the present disclosure has been described with reference to example implementations, workers skilled in the art will recognize that changes may be made in form and detail without departing from the spirit and scope of the claimed subject matter. For example, although different example implementations may have been described as including features providing one or more benefits, it is contemplated that the described features may be interchanged with one another or alternatively be combined with one another in the described example implementations or in other alternative implementations. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure. Although portions of the disclosure may use the phrase “at least one” or “one or more” of a particular component or element, unless otherwise specifically limited, the mere recitation of a single element or component does not preclude a plurality of such elements or components.

What is claimed is:

1. A spindling cleaning assembly for a harvesting unit of a cotton harvesting work vehicle, the spindling cleaning assembly comprising:
a housing panel configured to pivot relative to a housing of the harvesting unit about a pivot axis;
a fluid assembly having distributor tubes carried by the housing panel;
a column of applicator pads carried by the housing panel and spaced apart along the pivot axis, the applicator pads receiving fluid from the fluid assembly through the distributor tubes; and
a mounting assembly having a mounting bracket coupled to the housing of the harvesting unit and a spring configured to allow the housing panel to move along the pivot axis relative to the mounting bracket and housing of the harvesting unit.

2. The spindling cleaning assembly of claim 1, the mounting assembly further comprising:
an outer shaft surrounding the spring, wherein the outer shaft is attached to the mounting bracket, and wherein the spring internally contacts the outer shaft at a first end of the outer shaft; and
an inner shaft assembly slidably coupled to the outer shaft, wherein the inner shaft assembly extends through the outer shaft and through the spring, wherein the inner shaft assembly contacts the spring proximate a second end of the outer shaft opposite the first end, and wherein compression of the spring is configured to move the inner shaft assembly relative to the outer shaft.

3. The spindling cleaning assembly of claim 2, wherein the outer shaft defines a first cutout extending along the pivot axis and a second cutout extending along the pivot axis, wherein an internal ledge is formed between the first cutout and second cutout, wherein the spring is positioned within the first cutout, wherein in a first position of the mounting bracket, the spring produces a first spring force and the inner shaft assembly contacts the outer shaft outside of the outer shaft at the first end of the outer shaft, and wherein in a second position of the mounting bracket, the spring produces a second spring force greater than the first spring force and the inner shaft assembly rests against the internal ledge.

4. The spindling cleaning assembly of claim 3, wherein compressing the spring moves the mounting bracket from the first position to the second position, and wherein a distance between the first position and the second position defines a maximum movement along the pivot axis between the spindling cleaning assembly and the housing of the harvesting unit.

5. The spindling cleaning assembly of claim 2, wherein the outer shaft and mounting bracket form a single integral component.

6. The spindling cleaning assembly of claim 1, wherein during operation of the harvesting unit, a spindle holding bar of the harvesting unit passes the spindling cleaning assembly and spindles of the spindle holding bar contact the column of applicator pads, and wherein the contact between the spindles and the column of applicator pads generate a force causing the spring to compress moving the spindling cleaning assembly relative to the housing of the harvesting unit.

7. The spindling cleaning assembly of claim 1, wherein the mounting assembly is positioned at a first end of the spindling cleaning assembly, and wherein the spindling cleaning assembly further comprises a mounting member positioned at a second end of the spindling cleaning assembly opposite the first end, the mounting member positioned along the pivot axis.

8. The spindling cleaning assembly of claim 7, wherein the mounting member comprises a rod attached to the housing panel, and wherein the rod extends away from the housing panel along the pivot axis.

9. The spindling cleaning assembly of claim 1, further comprising a latching assembly configured to latch the housing panel against the housing of the harvesting unit, wherein when the housing panel is in a closed position and the latch assembly is in a first position, the latch assembly is configured to prevent rotation of the housing panel about the pivot axis, and wherein when the latch assembly is in a second position the latch assembly is configured to allow the housing panel to rotate about the pivot axis.

10. The spindling cleaning assembly of claim 9, wherein when the latching assembly is placed in the first position and the housing panel is the closed position, the latching assembly engages a sleeve of the housing of the harvesting unit, and wherein when the spring is compressed, the sleeve is configured to move in a direction of the pivot axis.

11. A harvesting unit of a cotton harvesting work vehicle, the harvesting unit comprising:
a housing;
a spindle drum mechanically coupled to the housing, the spindle drum comprising an array of spindle holding bars configured to rotate about a rotation axis of the spindle drum, wherein each spindle holding bar comprises a column of spindles;
a spindle cleaning assembly for cleaning and lubricating each spindle of the column of spindles, wherein during rotation of the spindle drum each spindle holding bar passes through the spindle cleaning assembly, the spindle cleaning assembly comprising:
a housing panel configured to pivot relative to the housing about a pivot axis;
a fluid assembly having distributor tubes carried by the housing panel;
a column of applicator pads carried by the housing panel and spaced apart along the pivot axis, the applicator pads receiving fluid from the fluid assembly through the distributor tubes; and
a mounting assembly having a mounting bracket coupled to the housing and a spring configured to allow the housing panel to move along the pivot axis relative to the mounting bracket and housing.

12. The harvesting unit of claim 11, the mounting assembly further comprising:
an outer shaft surrounding the spring, wherein the outer shaft is attached to the mounting bracket, and wherein the spring internally contacts the outer shaft at a first end of the outer shaft; and
an inner shaft assembly slidably coupled to the outer shaft, wherein the inner shaft assembly extends through the outer shaft and through the spring, wherein the inner shaft assembly contacts the spring proximate a second end of the outer shaft opposite the first end, and wherein compression of the spring is configured to move the inner shaft assembly relative to the outer shaft.

13. The harvesting unit of claim 12, wherein the outer shaft defines a first cutout extending along the pivot axis and a second cutout extending along the pivot axis, wherein an internal ledge is formed between the first cutout and second cutout, wherein the spring is positioned within the first cutout, wherein in a first position of the mounting bracket, the spring produces a first spring force and the inner shaft assembly contacts the outer shaft outside of the outer shaft at the first end of the outer shaft, and wherein in a second position of the mounting bracket, the spring produces a second spring force greater than the first spring force and the inner shaft assembly rests against the internal ledge.

14. The harvesting unit of claim 13, wherein compressing the spring moves the mounting bracket from the first position to the second position, and wherein a distance between the first position and the second position defines a maximum movement along the pivot axis between the spindling cleaning assembly and the housing of the harvesting unit.

15. The harvesting unit of claim 12, wherein the outer shaft and mounting bracket form a single integral component.

16. The harvesting unit of claim 11, wherein during operation of the harvesting unit, a spindle holding bar of the harvesting unit passes the spindling cleaning assembly and spindles of the spindle holding bar contact the column of applicator pads, and wherein the contact between the spindles and the column of applicator pads generate a force causing the spring to compress moving the spindling cleaning assembly relative to the housing of the harvesting unit.

17. The harvesting unit of claim 11, wherein the mounting assembly is positioned at a first end of the spindling cleaning assembly, and wherein the spindling cleaning assembly further comprises a mounting member positioned at a second end of the spindling cleaning assembly opposite the first end, the mounting member positioned along the pivot axis.

18. The harvesting unit of claim 17, wherein the mounting member comprises a rod attached to the housing panel, and wherein the rod extends away from the housing panel along the pivot axis.

19. The harvesting unit of claim 11, wherein the spindling cleaning assembly further comprises a latching assembly configured to latch the housing panel against the housing of the harvesting unit, wherein when the housing panel is in a closed position and the latch assembly is in a first position, the latch assembly is configured to prevent rotation of the housing panel about the pivot axis, and wherein when the latch assembly is in a second position the latch assembly is configured to allow the housing panel to rotate about the pivot axis.

20. The harvesting unit of claim 19, wherein when the latching assembly is placed in the first position and the housing panel is the closed position, the latching assembly engages a sleeve of the housing of the harvesting unit, and wherein when the spring is compressed, the sleeve is configured to move in a direction of the pivot axis.
